(19) United States
(12) Patent Application Publication
(10) Pub. No.: US 2026/0340926 A1
(43) Pub. Date: Oct. 29, 2026

(54) NEURAL RENDERING-BASED THREE-DIMENSIONAL VIRTUAL SPACE GENERATION METHOD AND SERVER THEREFOR

(71) Applicant: CJ OLIVENETWORKS CO., LTD., Seoul (KR)

(72) Inventors: Yi An SEO, Seoul (KR); Jun Gu CHO, Seoul (KR); Jongsoo SOHN, Seoul (KR)

(21) Appl. No.: 19/250,184

(22) Filed: Jun. 26, 2025

Related U.S. Application Data
(63) Continuation of application No. PCT/KR2023/021848, filed on Dec. 28, 2023.

(30) Foreign Application Priority Data
Dec. 30, 2022 (KR) 10-2022-0190320

(51) Int. Cl. G06T 15/04; G06T 7/194; G06T 7/20

(52) U.S. Cl. CPC G06T 15/04; G06T 7/194; G06T 7/20; G06T 2207/10016; G06T 2207/10024; G06T 2207/30196; G06T 2207/30244

(57) ABSTRACT

The present disclosure relates to a method of generating a three-dimensional virtual space based on neural rendering and a server therefor, and more particularly, to a method and server of generating a three-dimensional virtual space by removing a dynamic object from a two-dimensional video and then acquiring a spatial image, and collecting the two-dimensional video and rendering data from devices utilized to capture the two-dimensional video and then utilizing the spatial image and rendering data.

### CROSS REFERENCE TO RELATED APPLICATIONS

This application is a Bypass Continuation Application based on an International Application No. PCT/KR2023/021848 filed on Dec. 28, 2023, claiming priority based on Korean Patent Application No. 10-2022-0190320 filed on Dec. 30, 2022, the disclosures of which are incorporated herein by reference in their entireties.

### TECHNICAL FIELD

The present disclosure relates to a method of generating a three-dimensional virtual space based on neural rendering and a server therefor, and more particularly, to a method and server of generating a three-dimensional virtual space by removing a dynamic object from a two-dimensional video and then acquiring a spatial image, and collecting the two-dimensional video and rendering data from devices utilized to capture the two-dimensional video and then utilizing the spatial image and rendering data.

### BACKGROUND ART

Recently, with the development of related software and hardware, the demand for businesses that implement a three-dimensional virtual space and then utilize the same has increased significantly. The utilization of building a metaverse space at the entertainment level or building and simulating a three-dimensional virtual space to solve realistic problems such as traffic congestion at the public level, and securing three-dimensional data at dangerous construction sites to perform remote safety inspections, or the like is being actively discussed or some of them have actually been implemented. Meanwhile, the development of related technologies is also being supported rapidly. Various 3D-related technologies supporting metaverse, VR, AR, digital twins, and the like are being developed and shared.

Nowadays, three-dimensional capture devices are absolutely necessary to implement a three-dimensional virtual space. However, the capture devices are expensive and their purpose is limited only for three-dimensional work, so it basically takes a lot of cost and effort to implement a three-dimensional virtual space.

Meanwhile, as mentioned above, in order to meet the recent increase in three-dimensional virtual space needs, a more efficient and simpler method of generating three-dimensional virtual space is required than the current method.

The present disclosure has been proposed in consideration of those problems, and aims to greatly increase efficiency by implementing a three-dimensional virtual space from a universally captured two-dimensional video. Meanwhile, the present disclosure has been invented to provide additional technical elements that cannot be easily invented by those skilled in the art, in addition to solving the above technical problems.

### DISCLOSURE OF INVENTION

### Technical Problem

An aspect of the present disclosure is to provide an environment in which a three-dimensional virtual space can be easily implemented without an expensive three-dimensional capture device.

In particular, an aspect of the present disclosure is to allow the implementation of a three-dimensional virtual space with only general two-dimensional videos so as to improve the efficiency of a virtual space generation process.

In addition, an aspect of the present disclosure is to secure related data from capture devices used at the time of capturing a two-dimensional video so as to increase the accuracy of a three-dimensional virtual space to be implemented.

In addition, an aspect of the present disclosure is to allow the implemented three-dimensional virtual space to be utilized for various purposes.

Meanwhile, technical problems of the present disclosure are not limited to the above-mentioned problems, and other technical problems which are not mentioned herein will be clearly understood by those skilled in the art from the description below.

### Technical Solution

The present disclosure is to solve the foregoing problems, a method of generating a three-dimensional virtual space based on a two-dimensional video according to the present disclosure may include (a) generating a spatial image by removing a dynamic object from the two-dimensional video; (b) collecting rendering data from the two-dimensional video or at least one capture device that captured the two-dimensional video; and (c) generating the spatial image into a three-dimensional virtual space by referring to the rendering data.

Furthermore, in the method of generating a three-dimensional virtual space, the step (a) may include separating a dynamic object and a spatial image from the two-dimensional video; removing a dynamic object from the two-dimensional video; and acquiring a spatial image from the two-dimensional video.

Furthermore, in the method of generating a three-dimensional virtual space, the separating a dynamic object and a spatial image may include identifying an area in which a change in shape or color is detected in at least some of consecutive frames constituting the two-dimensional video.

Furthermore, in the method of generating a three-dimensional virtual space, the rendering data may include setting information including information on the posture or operation of a capture device that captured the two-dimensional video; and location information including information on a location where the two-dimensional video was captured, or a location where at least one capture device that captured the two-dimensional video was present.

Furthermore, in the method of generating a three-dimensional virtual space, the setting information may include at least one of focal length information of a lens in the capture device, posture information of the capture device, or capture time information.

Furthermore, in the method of generating a three-dimensional virtual space, the step (b) may further collect rendering data from library data that can be searched from an arbitrary database.

Furthermore, in the method of generating a three-dimensional virtual space, the step (c) may include loading a plurality of spatial images and rendering data; configuring specific spatial information by referring to the spatial images and rendering data; and generating a three-dimensional virtual space structure based on the configured spatial information.

Furthermore, in the method of generating a three-dimensional virtual space, the method may further include rendering a texture on the three-dimensional virtual space structure subsequent to generating the three-dimensional virtual space structure.

Furthermore, in the method of generating a three-dimensional virtual space, the plurality of spatial images may be acquired from two-dimensional videos respectively captured from different points of view.

Meanwhile, in a server that generates a three-dimensional virtual space according to another embodiment of the present disclosure, the server including a central processing unit and a memory, the central processing unit executing instructions for executing a method of generating a three-dimensional virtual space stored in the memory, the method of generating a three-dimensional virtual space may include (a) generating a spatial image by removing a dynamic object from the two-dimensional video; (b) collecting rendering data from the two-dimensional video or at least one capture device that captured the two-dimensional video; and (c) generating the spatial image into a three-dimensional virtual space by referring to the rendering data.

### Advantageous Effects

According to the present disclosure, there is an effect that can generate a three-dimensional virtual space with relatively little cost and effort, and in particular, there is an effect that can generate a three-dimensional virtual space with only a two-dimensional video.

In addition, according to the present disclosure, not only data items that can be acquired from a two-dimensional video, but also data may be collected from capture devices or peripheral devices at the time of capturing the two-dimensional video, and utilized to implement a three-dimensional virtual space, thereby having an effect that can increase the accuracy of the ultimately generated three-dimensional virtual space.

Meanwhile, the effects of the present disclosure may not be limited to the above-mentioned effects, and other technical effects which are not mentioned herein will be clearly understood by those skilled in the art from the description below.

### BRIEF DESCRIPTION OF THE DRAWINGS

FIG. 1 shows a drawing for conceptually understanding a method of generating a three-dimensional virtual space proposed in this detailed description.

FIG. 2 shows a flowchart according to a method of generating a three-dimensional virtual space according to the present disclosure.

FIG. 3 shows a flowchart of acquiring a spatial image from a two-dimensional video in more detail.

FIG. 4 shows a drawing for explaining a process of removing a dynamic object from a two-dimensional video.

FIG. 5 is a drawing for explaining an embodiment of collecting rendering data.

FIG. 6 shows a flowchart of generating a three-dimensional virtual space by referring to rendering data in more detail.

### BEST MODE FOR CARRYING OUT THE INVENTION

The details of the objects and technical configurations of the present disclosure and operational effects thereof will be more clearly understood from the following detailed description based on the accompanying drawings appended hereto. Hereinafter, embodiments according to the present disclosure will be described in detail with reference to the accompanying drawings.

Embodiments disclosed herein should not be interpreted as limiting or used to limit the scope of the present disclosure. It is apparent for those skilled in the art that a description including embodiments herein has various applications. Therefore, any embodiments described in the detailed description of the present disclosure are illustrative for better understanding of the present disclosure and are not intended to limit the scope of the present disclosure to the embodiments.

Functional blocks illustrated in the drawings and described hereunder are only examples of possible implementations. In other implementations, other functional blocks may be used without departing from the concept and scope of the detailed description. Furthermore, one or more functional blocks of the present disclosure are illustrated as separate blocks, but one or more of the functional blocks of the present disclosure may be a combination of various hardware and software elements that execute the same function.

In addition, an expression that some elements are “included” is an expression of an “open type”, and the expression simply denotes that the corresponding elements are present, but should not be construed as excluding additional elements.

Moreover, in case where it is mentioned that one element is “connected” or “coupled” to the other element, it should be understood that one element may be directly connected to the other element, but another element may be present therebetween.

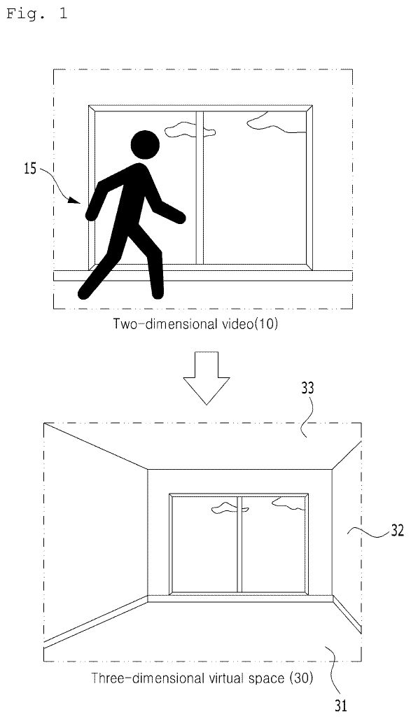

FIG. 1 shows a drawing for conceptually understanding a method of generating a three-dimensional virtual space according to the present disclosure. Referring to the drawings, the present disclosure basically relates to a method of implementing a three-dimensional virtual space 31 from a two-dimensional video 10, wherein a dynamic object 15 included in the two-dimensional video 10, for example, an object moving in the video, such as a person walking as in the drawing, may be removed so as to acquire only an image on the space, and generate a three-dimensional virtual space 30 by referring to various rendering data based on the spatial image acquired in this manner.

For reference, the term two-dimensional video to be mentioned in this detailed description strictly refers to image data captured by a conventional universal capture device (camera), and may generally refer to an image created for the purpose of being displayed or output on a flat (or curved) screen. A two-dimensional video may refer to, for example, a movie video displayed on a movie theater screen, a drama video displayed through a television screen at home, and an animation video played on a PC monitor screen.

Conversely, the term three-dimensional virtual space to be mentioned in this detailed description refers to data utilized to implement, for example, a VR or AR environment, and may refer to output data that allows a viewer (user) to have an experience as if he or she is present in a specific space to change a point of view according to the viewer's (user's) movement. A three-dimensional virtual space may be, for example, data output from a VR device to provide an experience similar to being in a real space when the viewer (user) wears the VR device. Alternatively, assuming that there is a system that can implement an arbitrary virtual environment using multiple projectors in a specific space (such as a closed hexahedral room), it may be data required to implement the arbitrary virtual environment. As such, the term three-dimensional virtual space mentioned in this detailed description may refer to data required to implement an environment sufficient to be recognized by the user as a three-dimensional space, or video (image) data for outputting as a three-dimensional space.

Referring again to FIG. 1, it can be confirmed that the three-dimensional virtual space 30 on the right includes a floor surface 31, left and right wall surfaces 32, a ceiling surface 33, and the like, and the virtual space may be rendered to change in real time according to the user's movement, especially gaze movement and walking movement.

In the above, an overview of a method of generating a three-dimensional virtual space according to the present disclosure has been described with reference to FIG. 1.

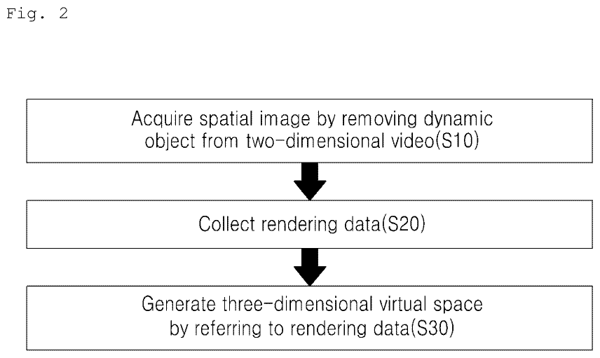

FIG. 2 shows a schematic sequence of a method of generating a three-dimensional virtual space according to the present disclosure. When referring to the drawing, a method of generating a three-dimensional virtual space may include generating a spatial image by removing a dynamic object from a two-dimensional video (S10), collecting rendering data required to implement a virtual space from the two-dimensional video or a capture device that captured the two-dimensional video (S20), and generating the spatial image into a three-dimensional virtual space by referring to the rendering data (S30). Respective steps will be described in detail.

Step S10 may be understood as recognizing a dynamic body (dynamic object) appearing in a two-dimensional video, and removing the dynamic object so as to leave only image information on a space from the two-dimensional video. In order to convert a space appearing in a two-dimensional video into a virtual three-dimensional space, it is necessary to separate image information on the space and image information on a dynamic object (a body that moves independently of the movement of the camera, such as a person or thing) in the two-dimensional video. In this case, a large amount of image data may be utilized to quickly generate a mask through image segmentation using an artificial intelligence model that has been trained in advance for an object (person, animal, etc.) that is expected to be separated to separate from spatial image information, and an area to be removed may be designated according to the user's intention to allow the server to perform a separation operation between a dynamic object and a spatial image.

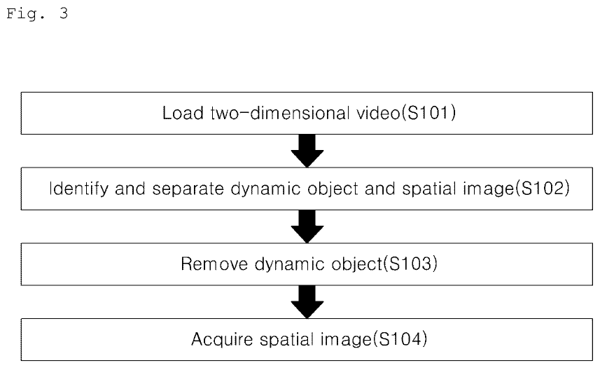

FIG. 3 shows further detailed steps of step S10. Referring to the drawing, step S10 may first start from loading a two-dimensional video (S101). This step may be understood as loading a two-dimensional video that is the target of the image process into a memory, and this step may involve operator actions of loading the two-dimensional video in a program having an editing interface on an operator's (editor's) computer after executing the program. Meanwhile, it is understood that the two-dimensional video is not limited to just one, and a plurality of videos can be loaded as needed.

Subsequent to step S101, identifying and separating a dynamic object and a spatial image from the two-dimensional video (S102) may be executed. It is to be understood that a process of identifying a dynamic object and a process of identifying a spatial image may be carried out simultaneously, but even if this is not the case, a result may be obtained in which a spatial image is naturally identified as a remaining portion when a process of identifying a dynamic object from a two-dimensional video is completed.

Identification of a dynamic object or identification of a spatial image may be accomplished by detecting changes in a plurality of frames constituting the two-dimensional video. For a body moving in a video, changes in pixel values are necessarily caused for each consecutive frame, and an area where such changes in pixel values are detected may be identified as a dynamic object. Alternatively, in the same context, if there is an area in which a change in shape or color of an object is detected in at least some of consecutive frames, a closed area corresponding to the area may be estimated and identified as a dynamic object. In contrast to a dynamic object, an area where no change is detected in a plurality of consecutive frames may be implemented to be identified as a spatial image.

Meanwhile, trained artificial intelligence algorithms may be utilized in the process of identifying a dynamic object or spatial image. The step S102 may be performed quickly and accurately by utilizing an artificial intelligence algorithm that has learned the process of identifying a dynamic object such as a person, a car, and an animal from a large amount of two-dimensional videos for learning, or an artificial intelligence algorithm that has learned the process of identifying and separating such a dynamic object and an arbitrary spatial image. On the other hand, an interface may be provided to designate an area in which a dynamic object is present, and thus an area to be removed, according to the intention of the operator (editor). If the operator (editor) can arbitrarily designate a dynamic object to be removed or an area including such a dynamic object on a specific frame, the server may reduce resources when executing step S102, and the operation speed and accuracy may be improved accordingly.

Subsequent to step S102, removing the identified dynamic object (S103) and acquiring a spatial image (S104) may be executed. In the step S103, since dynamic objects are identified for each frame, an operation of removing the corresponding area from the image frame may be executed, and a masking technology may be utilized in this step. Additionally, in an area where a dynamic object has been removed or a masking area, pixel values may be determined by referring to an area around the area where the dynamic object was present.

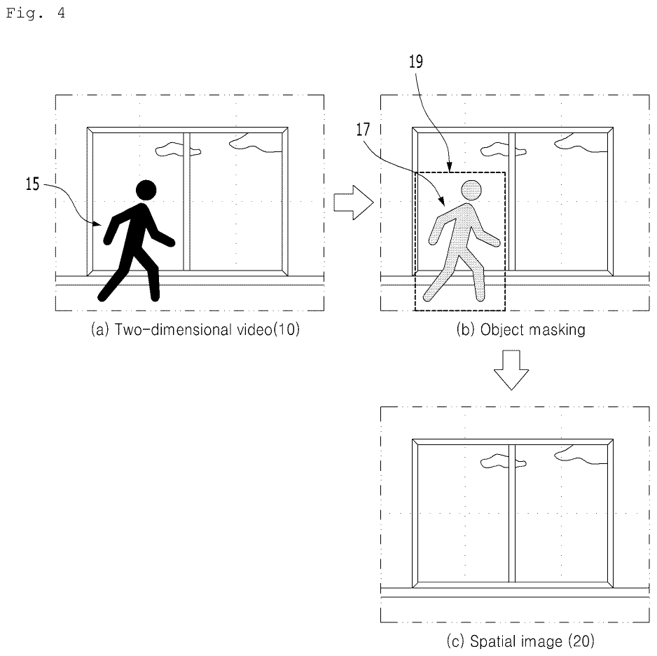

FIG. 4 shows a process in which a moving person, that is, the dynamic object 15, is removed from the two-dimensional video 10. Assuming that the two-dimensional video 10 includes a person walking in a space in front of a window, the walking person may be defined as the dynamic object 15. In this case, continuous frames that make up the two-dimensional video 10 may include a s shape of a person walking, and in step S102, the walking person and the background spatial image may be identified. In addition, in order to remove a walking person while leaving only a spatial image, a masking area 17 of the same shape may be defined, and for the masking area 17, pixel values may be determined by referring to the shape or color of the surrounding spatial image, that is, a window, a floor surface, and the like, so as to allow a spatial image 20 such as (c) of FIG. 4 to be generated. In addition, in (b) of FIG. 4, it can be confirmed that an arbitrary area 19 is designated with a dotted line, wherein the arbitrary area can be designated by an operator (editor) and may be an area that guides the server to where a dynamic object is present, and therefore, to which area an image process such as masking should be performed. A process of designating the arbitrary area 19 may involve an action of the operator (editor) dragging a mouse or touch input means, or specifying a plurality of (at least three or more) points to define one closed area.

In the above, with reference to FIGS. 3 and 4, a process of removing a dynamic object from a two-dimensional video and a process of acquiring a spatial image have been described.

Next, the collecting of rendering data required to implement a virtual space (S20) will be described. Rendering data may refer to any type of data required to implement a three-dimensional virtual space, and there is no limitation on the type of data. However, preferably, at least setting information, which is information on the posture or operation of a capture device that captured the two-dimensional video, and location information, which is information on a location where the two-dimensional video was captured or a location where at least one capture device that captured the two-dimensional video was present, may be included.

When a two-dimensional video is captured, there must be at least one capture device that captured the image, and in this step, at least one setting information among information items recorded when the capture device was operated for capture or shared with a separate server (database) linked to a network, for example, focal length information of a lens in the capture device, posture information of the capture device (a set of values measured as the capture device rotates around axes that define a stereoscopic space), or capture time information may be collected. Additionally, location information at the time the two-dimensional video was captured may be recorded in the capture device or stored in a separate server (database) linked to the capture device via a network, and such location information may also be collected. Meanwhile, rendering data may be collected not only from the capture device, but also from peripheral devices required to facilitate capturing, or personal devices carried by staff members at the time of capturing.

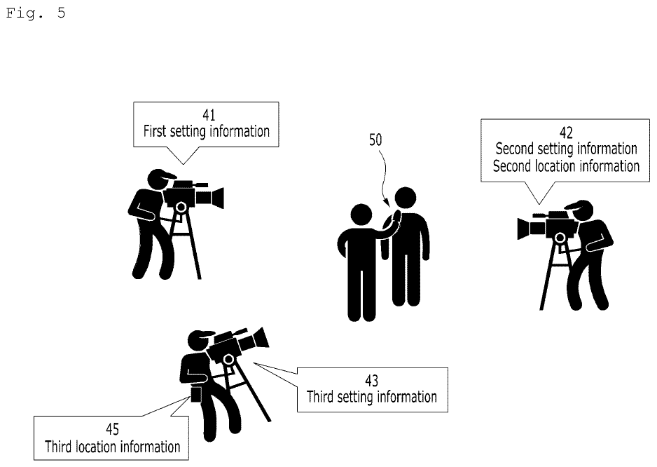

FIG. 5 shows a site where a two-dimensional video is being captured, and it can be confirmed that at the site, there are at least three capture devices 41 to 43, a personal device carried by a staff member (e.g., a smartphone 45), and one peripheral device (microphone 50). In the foregoing description, it has been described that rendering data can be collected from respective capture devices, wherein for example, setting information items that can be recorded when each of the capture devices is operated may be stored in the first capture device 41 to the third capture device 43, and in some cases, the setting information items may be stored in a separate server or database via a network or other copying means. The respective capture devices may have different functions, and therefore, the types of information that can be shared from the respective capture devices may also differ. For example, the first capture device 41 or the third capture device 43 may record and share only setting information (first setting information, third setting information) such as lens focal length information and posture information, and the second capture device 42 may record and share not only second setting information (lens focal length information, posture information, etc.) but also location information of a current location of the second capture device 42. On the other hand, there are a number of staff members at the capturing site, and respective staff members may carry a personal device 45, such as a smartphone, and the rendering data may be collected or shared from those personal devices. In this case, location information or the like recorded on the personal device may be utilized based on a time zone matching that in which the setting information or the location information of the capture devices is recorded. In addition, at the capturing site, in addition to the capture devices and personal devices, there may be additional devices required for capturing, that is, peripheral devices, and for example, there may be additional peripheral devices such as a microphone 50. In one embodiment, a peripheral device such as the microphone 50 may be provided with a function capable of recording and sharing current location information, and may be implemented to store current location information in a designated storage or a server (database) on a network while the peripheral device is in operation. Meanwhile, the mentioned server (database) may store information items (setting information, location information, etc.) shared from the devices by mapping them to one another.

The rendering data may be collected directly by an arbitrary server from the aforementioned devices (capture device, personal device, peripheral device, etc.), but the rendering data may also be collected from previously stored rendering data, so-called library data that can be searched from an arbitrary database, at a time point when a three-dimensional virtual space is to be generated. That is, assuming that rendering data items at the time a two-dimensional video was captured is recorded or shared as a library together with the two-dimensional video in an arbitrary server, the operator (editor) may search for and load a specific two-dimensional video and simultaneously acquire the related rendering data items.

For reference, library data may be stored by an arbitrary entity uploading it into the arbitrary database, and in this case, when uploading a two-dimensional video or rendering data corresponding thereto to the arbitrary database, a predetermined reward may be provided to the entity who uploaded it. For example, if a general user who captured a smartphone video of about 3 minutes at a specific location uploads the smartphone video (two-dimensional video) or, furthermore, uploads rendering data corresponding thereto (smartphone posture information and location information recorded in the smartphone at the time the smartphone video was captured), the user may be provided with a reward such as point or coupon issuance. The entities that can upload two-dimensional video or rendering data are not necessarily limited to individual users, and uploads may also be made by companies that produce content, especially companies that capture content by utilizing professional video capture devices, or companies that manage content, and a reward may also vary depending on the entity. Through this, two-dimensional videos and rendering data generated by various entities may be stored in a library, and the server according to the present disclosure may use this as a reference in a process of generating a three-dimensional virtual space.

Meanwhile, in the description referring to FIG. 5, only a capture device, a personal device, and a peripheral device have been mentioned as examples of devices capable of generating rendering data, but if there is a device that has a function to automatically generate and store related records at a time point of capturing or generating a two-dimensional video, such a device may also be considered a device capable of generating rendering data. When the server searches for the library data, a primary search may be performed based on location information, particularly GPS information and address information, and at least some of the two-dimensional videos or rendering data items searched based on the location information may be utilized to generate a three-dimensional virtual space.

On the other hand, the rendering data that can be collected at step S20 may not necessarily have been automatically recorded by a specific device. When capturing a specific two-dimensional video, the arrangement of the capture devices may be entered by the operator (editor) in a space screen with fixed specifications, and the input data may also be utilized as a type of rendering data. Moreover, the hardware specifications of each capture device may also be entered by the operator (editor), and the hardware specifications may also be a type of rendering data required to implement a three-dimensional virtual space.

Additionally, the rendering data that can be collected at step S20 may also be acquired from the two-dimensional video itself. For example, metadata included in a two-dimensional video may be utilized as rendering data, or if the location of the capture device or the posture of the capture device at the time of capturing can be estimated by analyzing the two-dimensional video, information items estimated through image analysis in this way may be utilized as rendering data.

In this way, step S20 may be collecting all types of data (rendering data) required to implement a three-dimensional virtual space from a two-dimensional spatial image, wherein the rendering data to be collected may be automatically recorded, generated, and shared by the capture device, or the like, or arbitrarily entered by the operator (editor), regardless of its source and generation method.

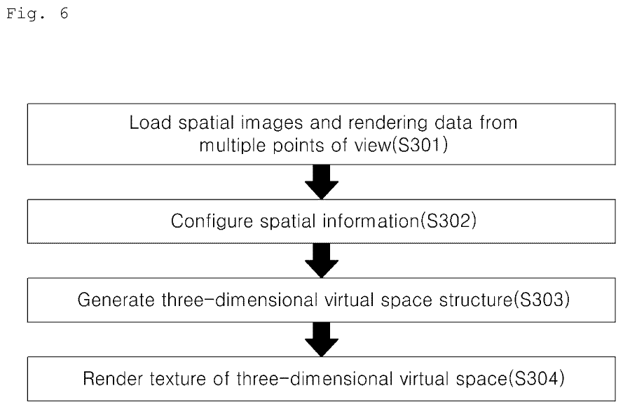

Lastly, step S30 of generating a three-dimensional virtual space will be described with reference to rendering data. FIG. 6 shows steps that subdivide step S30 in detail, and referring to the steps, the step S30 may include loading spatial images and rendering data from multiple points of view (S301), configuring spatial information (S302), generating a three-dimensional virtual space structure (S303), and rendering a texture of a three-dimensional virtual space (S304).

A three-dimensional virtual space may be generated by utilizing two-dimensional spatial images and rendering data corresponding thereto, especially setting information and location information generated by capture devices. By utilizing video and spatial images captured from multiple points of view for a single space, stereoscopic information of the space may be estimated, and the estimated stereoscopic information may be used to express structural information of the space. Furthermore, by referring to a spatial image corresponding thereto, the texture of the space may be expressed so as to reproduce a three-dimensional virtual space.

Step S301 is loading spatial images and rendering data required to implement a three-dimensional virtual space, and may be understood as loading spatial images obtained as a result of the image process in the previous steps and the collected rendering data items into a memory. In order to configure a three-dimensional space, two-dimensional videos captured from multiple of points of view, more precisely, spatial images acquired from those two-dimensional videos, may be required, wherein those spatial images may be obtained through an image processing process of a plurality of frames in the two-dimensional video. On the other hand, spatial images from multiple points of view may not be based solely on a single two-dimensional video, but may be a result of image processing of another two-dimensional video. For example, assuming that three different two-dimensional videos are captured at the same location (same set, same local attraction, etc.), multiple spatial images may be acquired from the three different images, wherein those spatial images, especially those acquired from the three different images, have more various points of view, and thus all of those spatial images may be utilized.

Step S302 is configuring arbitrary spatial information by referring to the spatial images and rendering data. The meaning of configuring spatial information may refer to defining the parameters required to define a virtual stereoscopic space. For example, in order to determine a single stereoscopic space, at least a height and width of the wall surface, a horizontal and vertical length of the floor surface, a horizontal and vertical length of the ceiling surface, and furthermore, a thickness of the wall surface, a height and width of the window frame installed on the wall surface, and the like, must be determined to distinguish the space, and the values for those spatial parameters may be determined in this step. In addition, various types of accessories may be arranged in a stereoscopic space, and the locations and shapes of those accessories may be determined based on a spatial image of the two-dimensional video most recently captured based on a current point in time.

Step S303, which is generating a structure of a three-dimensional virtual space, may also be understood as outputting a virtual space in a form that can be recognized by the operator (editor). If the previous step S302 was defining a specific stereoscopic space, step S303 may be visualizing and displaying it. Meanwhile, in this step, the server may provide an editing interface to the operator (editor) so as to allow him or her to directly modify a portion of the displayed virtual space that needs to be modified. For example, by allowing the operator to directly modify parameter values such as a length and width of the floor surface, a thickness of the wall surface, and a slope of the ceiling surface, the structure of the virtual space may be edited according to the operator's intention.

Step S304 is rendering the texture of the previously generated virtual space. Respective surfaces of the generated virtual space, respective accessories, may actually be made of their own unique materials, and even in the virtual space, the texture may be rendered similarly to make it look like a real space or thing as much as possible. Texture rendering may refer to a spatial image. That is, texture rendering may be performed by comparing a virtual space and a spatial image to apply a surface in the corresponding spatial image to the virtual space area.

In the above, with reference to the drawings, a method of generating a three-dimensional virtual space according to the present disclosure has been described.

Meanwhile, the three-dimensional virtual space generated according to the above method may be utilized in various ways. For example, after watching video content such as movies or dramas, when a consumer (viewer) wants to consume additional content, a metaverse marketing utilizing a virtual space such as providing a three-dimensional virtual space for a space that appeared in a two-dimensional video and selling related products or services in the virtual space may be planned, and furthermore, it may also be possible to produce secondary creative works (webtoons, fan art, etc.) using three-dimensional data about the space.

In addition, for factories or environments that are difficult for people to directly monitor or work on, two-dimensional videos may be captured by using conventional capturing methods to reproduce a three-dimensional virtual space for efficient monitoring, and a three-dimensional virtual space-based simulation environment may be configured to perform tests for various conditions and scenarios so as to be utilized to cope with accidents, to maintain predictions, to test optimization, and the like.

For reference, the three-dimensional virtual space generation method may be executed by an arbitrary computing device, such as a server. The type of the server may be at least one server computer managed by a specific operator or may be a type of cloud server provided by another company, that is, a type of cloud server that the operator can sign up to use. When the server is implemented as a server PC, the server may include a central processing unit and a memory. In this case, the central processing unit may also be referred to as a controller, a microcontroller, a microprocessor, a microcomputer, or the like. Furthermore, the central processing unit may be implemented by hardware or firmware, software, or a combination thereof, and configured to include an application specific integrated circuit (ASIC) or a digital signal processor (DSP), a digital signal processing device (DSPD), a programmable logic device (PLD), or a field programmable gate array (FPGA) when implemented using hardware, and configured with firmware or software to include a module, a procedure, a function or the like that performs the foregoing functions or operations when implemented using firmware or software. In addition, the memory may be implemented as Read Only Memory (ROM), Random Access Memory (RAM), Erasable Programmable Read Only Memory (EPROM), Electrically Erasable Programmable Read-Only Memory (EEPROM), flash memory, Static RAM (SRAM), a hard disk drive (HDD), a solid state drive (SSD) or the like.

In the above, a method of generating a three-dimensional virtual space according to the present disclosure and a server therefor have been described. Meanwhile, the present disclosure is not limited to the foregoing specific embodiments and application examples, it will be of course understood by those skilled in the art that various modifications may be made without departing from the gist of the present disclosure as defined in the following claims, and it is to be noted that those modifications should not be understood individually from the technical concept and prospect of the present disclosure.

10 two-dimensional video 30 three-dimensional virtual space 31 Floor surface 32 Wall surface 33 Ceiling surface 41 First capture device 42 Second capture device 43 Third capture device 50 Microphone

1. A method of generating a three-dimensional virtual space based on a two-dimensional video, the method comprising:
(a) generating a spatial image by removing a dynamic object from the two-dimensional video;
(b) collecting rendering data from the two-dimensional video or at least one capture device that captured the two-dimensional video; and
(c) generating the spatial image into a three-dimensional virtual space by referring to the rendering data.

2. The method of claim 1, wherein the step (a) comprises:
separating a dynamic object and a spatial image from the two-dimensional video;
removing a dynamic object from the two-dimensional video; and
acquiring a spatial image from the two-dimensional video.

3. The method of claim 2, wherein the separating a dynamic object and a spatial image comprises:
identifying an area in which a change in shape or color is detected in at least some of consecutive frames constituting the two-dimensional video.

4. The method of claim 1, wherein the rendering data comprises:
setting information including information on the posture or operation of a capture device that captured the two-dimensional video; and
location information including information on a location where the two-dimensional video was captured, or a location where at least one capture device that captured the two-dimensional video was present.

5. The method of claim 4, wherein the setting information comprises:
at least one of focal length information of a lens in the capture device, posture information of the capture device, or capture time information.

6. The method of claim 1, wherein the step (b) further collects rendering data from library data that can be searched from an arbitrary database.

7. The method of claim 1, wherein the step (c) comprises:
loading a plurality of spatial images and rendering data;
configuring specific spatial information by referring to the spatial images and rendering data; and
generating a three-dimensional virtual space structure based on the configured spatial information.

8. The method of claim 7, further comprising:
rendering a texture on the three-dimensional virtual space structure subsequent to generating the three-dimensional virtual space structure.

9. The method of claim 7, wherein the plurality of spatial images are acquired from two-dimensional videos respectively captured from different points of view.

10. A server that generates a three-dimensional virtual space, the server comprising a central processing unit and a memory,
the central processing unit executing instructions for executing a method of generating a three-dimensional virtual space stored in the memory,
wherein the method of generating a three-dimensional virtual space comprises:
(a) generating a spatial image by removing a dynamic object from the two-dimensional video;
(b) collecting rendering data from the two-dimensional video or at least one capture device that captured the two-dimensional video; and
(c) generating the spatial image into a three-dimensional virtual space by referring to the rendering data.
